(19) United States
(12) Patent Application Publication
(10) Pub. No.: US 2020/0376765 A1
(43) Pub. Date: Dec. 3, 2020

(54) PACKAGE AND SYSTEM FOR POWDER USED IN ADDITIVE MANUFACTURING

(71) Applicant: WEMATTER AB, Linköping (SE)

(72) Inventor: Robert KNIOLA, Linköping (SE)

(73) Assignee: WEMATTER AB, Linköping (SE)

(21) Appl. No.: 16/604,722

(22) PCT Filed: Apr. 12, 2018
(86) PCT No.: PCT/SE2018/050374

§ 371 Date: Oct. 11, 2019

(30) Foreign Application Priority Data
Apr. 12, 2017 (SE) 1750442-4

(51) Int. Cl. B29C 64/321; B29C 64/255; B65D 83/06; F16K 3/08

(52) U.S. Cl. CPC B29C 64/321; B29C 64/255; B33Y 30/00; F16K 3/085; B65D 83/06

(57) ABSTRACT

Disclosed is a package (100) for powder for additive manufacturing comprising a body (110), a top (120), and a bottom (130), wherein the bottom (130) comprises a first part (200) having an inlet aperture and an outlet aperture, and a second part (300) having an inlet aperture and an outlet aperture. The second part is displaceable relative to the first part and in a closed position, the first part (200) is offset relative to the second part (300), such that neither of the inlet aperture and the outlet aperture of the first part (200) overlap with either of the inlet aperture and the outlet aperture of the second part (300). In an open position, the inlet aperture of the first part (200) is aligned with the inlet aperture of the second part (300) and the outlet aperture of the first part (200) is aligned with the outlet aperture of the second part (300).

### TECHNICAL FIELD

The present solution relates to a package for powder, especially powder used in additive manufacturing of objects, such as sinterable powder.

### BACKGROUND ART

Manufacturing three-dimensional objects is something that is well known within the art, and is generally referred to additive manufacturing. One form of additive manufacturing is sintering, which uses high temperature in order to shape sinterable powder into an object. The powder is typically comprised of a polymer composition or a metal alloy, and an energy beam, such as a laser, is used to cause the powder particles to fuse to one another. The process is usually based on dividing a model into layers, then manufacturing the object one layer at a time.

The powder used for additive manufacturing, such as sinterable powder, is generally comprised of material that may be harmful to humans, especially if it would get into the eyes or respiratory system of a person or other similarly sensitive areas, such as if the powder would be inhaled or digested.

Furthermore, most sintering systems used today are for industrial facilities but as the technology develops, it becomes increasingly interesting to also adapt it for personal use and other environments such as offices and hospitals. However, the average user in such settings is likely not as educated about the system as a person using a sintering system adapted for industrial use, does not have the proper clothing, equipment, ventilation or knowledge about the handling of powder used for the additive manufacturing process.

Thus, it would be desirable to find better and safer ways to handle powder that is used in additive manufacturing.

### SUMMARY

It is an object of the solution to address at least some of the problems and issues outlined above. It is possible to achieve these objects and others by using devices and systems as defined in the attached independent claims.

According to one aspect, there is provided a package for powder for additive manufacturing having an open position and a closed position. The package comprises a body, a top, disposed at the top of the body and a bottom, disposed at the bottom of the body. The bottom comprises a first part having an inlet aperture and an outlet aperture, spaced apart from each other and a second part having an inlet aperture and an outlet aperture, spaced apart from each other, wherein the second part is displaceable relative to the first part. In the closed position, the first part is offset relative to the second part, such that neither of the inlet aperture and the outlet aperture of the first part overlap with either of the inlet aperture and the outlet aperture of the second part, and in the open position, the inlet aperture of the first part is aligned with the inlet aperture of the second part and the outlet aperture of the first part is aligned with the outlet aperture of the second part. A package as described above achieves a safe solution for handling powder for additive manufacturing, that minimizes the risk of powder exiting the package inadvertently.

According to an optional embodiment, the first part of the bottom comprises two protrusions, for engaging with a receiving device. According to another optional embodiment, in the closed position, the second part is offset with approximately 90° relative to the first part.

According to an optional embodiment, the package further comprises a sensor for sensing if the package is in proximity of a compatible receiving device. By having such a sensor, the user is provided with further guidance for using the package correctly and further minimizing the risk of coming into contact with powder.

According to an optional embodiment, the top and the bottom of the package are circular and the body is cylindrical. By having such a shape, the powder may easily exit the package and the risk of unused powder getting stuck in the package is minimized.

According to an optional embodiment, the package further comprises a mechanical latching device for locking the second part of the bottom relative to the first part of the bottom, until the package comes into contact with a compatible receiving device. Such a mechanical latching device may e.g. be a spring-loaded pin.

The above devices and systems may be configured and implemented according to other different optional embodiments. Further possible features and benefits of this solution will become apparent from the detailed description below.

According to a second aspect, there is provided a system for filling of powder in additive manufacturing, comprising a package according to the first aspect, and a receiving portion. The receiving portion comprises an opening and an inlet aperture, wherein the receiving portion is adapted to engage with the bottom of the package, such that the package can only be opened after engagement of the bottom and the receiving portion, and subsequent rotation of the package.

According to an optional embodiment, the first part of the bottom of the package comprises two protrusions and the receiving portion comprises two recesses adapted to engage with the protrusions of the second part.

According to an optional embodiment, the inlet aperture of the second part is adapted to be inserted into the opening of the receiving portion.

According to an optional embodiment, the package comprises a first sensor and the receiving portion comprises a second sensor, wherein the first sensor and/or the second sensor is adapted to sense if it is in the vicinity of the other of the first and/or second sensor. In some embodiments, both sensors are adapted to simultaneously sense and/or detect the presence of another sensor. In some embodiments, the package and/or the receiving device may further be provided with visual means for indicating when the sensors come into proximity of each other or approach proximity of each other.

According to an optional embodiment, the package can only be moved to the open position if the first sensor is in proximity of the second sensor.

The aspects and embodiments described above are freely combinable with each other.

### SHORT DESCRIPTION OF THE DRAWINGS

The solution will now be briefly described, by way of example, with reference to the accompanying drawings, in which:

FIG. 1 shows a package according to the present disclosure.

FIG. 2 shows an exploded diagram of a package according to the present disclosure.

FIGS. 3a and 3b show a first and second part of a bottom of a package according to the present disclosure.

FIGS. 4a and 4b show a receiving part of a system according to the present disclosure, for receiving the package.

FIG. 5 shows an interaction between a package according to the present disclosure and a device into which the powder is to be filled.

### DESCRIPTION OF EMBODIMENTS

In the following, a detailed description of the different embodiments of the solution is disclosed with reference to the accompanying drawings. All examples herein should be seen as part of the general description and are therefore possible to combine in any way in general terms. Individual features of the various embodiments and methods may be combined or exchanged unless such combination or exchange is clearly contradictory to the overall function of the implementation.

Shortly described, the present disclosure relates to a package for powder used in additive manufacturing. Such powder is generally harmful to users, and therefore it is desirable to minimize the risk of powder coming into contact with sensitive areas of users. This is especially important in settings where the users may lack experience, such as home or office environments, or hospitals. The package of the present disclosure helps minimize the risk of users coming into contact with the powder, by providing a mechanism for ensuring that the powder cannot exit the package by accident, by the package having a closed position and an open position. This is done by way of a bottom of the package comprising two parts, which have to be aligned in a certain way in order for the powder to be able to exit the package. Further, in some embodiments the package is only possible to open when it comes into contact with a compatible receiving portion, such as in a receiving device of a powder container of a sintering system.

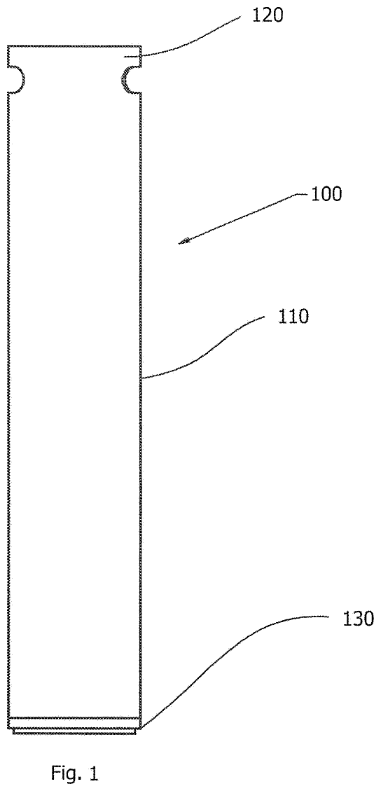

FIG. 1 shows a package 100 according to the present disclosure, comprising a hollow body 110, a top 120 and a bottom 130. The body is in a preferred embodiment cylindrical in shape, which is an advantageous shape for ensuring that as little powder as possible, preferably no powder at all, is left in the package after emptying it. The length and width of the package, or the diameter in embodiments wherein the body is cylindrical, is preferably in the range of 80-200 mm, more preferably around 120 mm. The height of a package can vary depending on the amount to be filled, but is typically such that the total volume of powder that can fit into the package is between 5 and 30 liters.

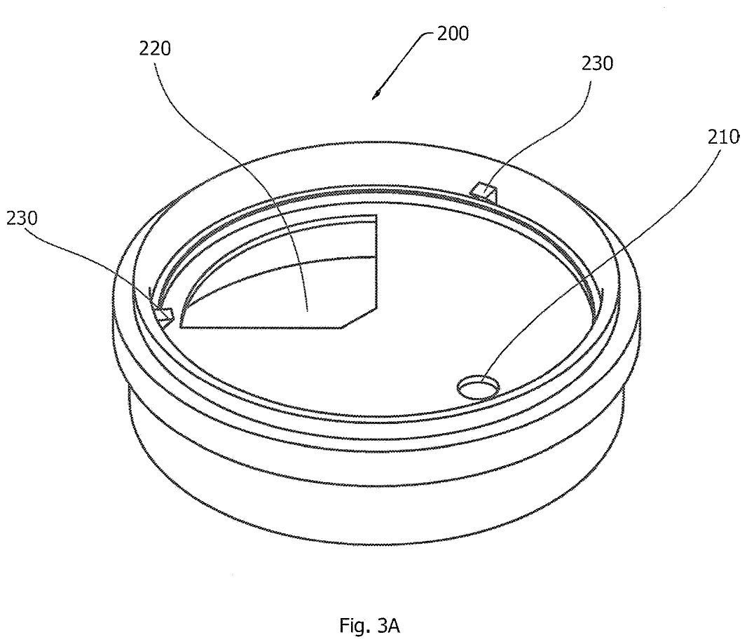

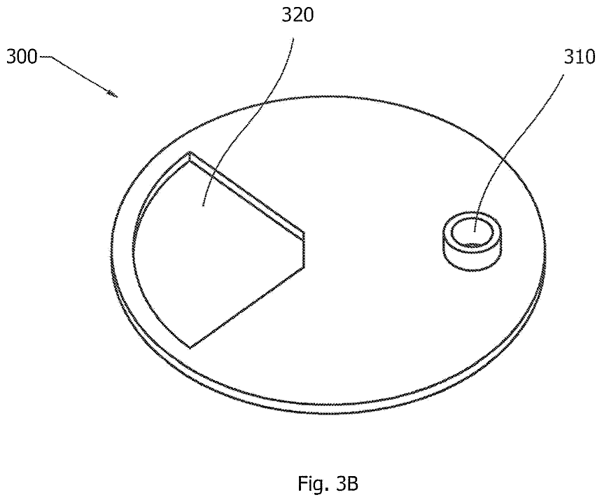

The top 120 is preferably provided with gripping means, such that a user can hold and carry the package 100. In a preferred embodiment, the gripping means are adapted to be possible to grab with two hands, e.g. by having recesses or handles, which facilitates rotating the package when it is inserted into a powder container. The package 100 further comprises a bottom 130, which will be described more in detail with reference to FIGS. 3a and 3b.

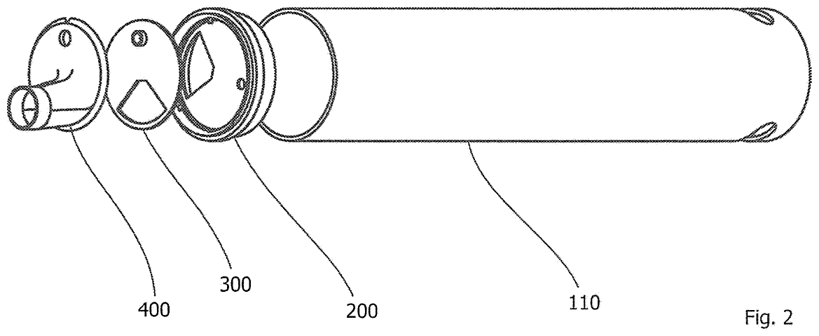

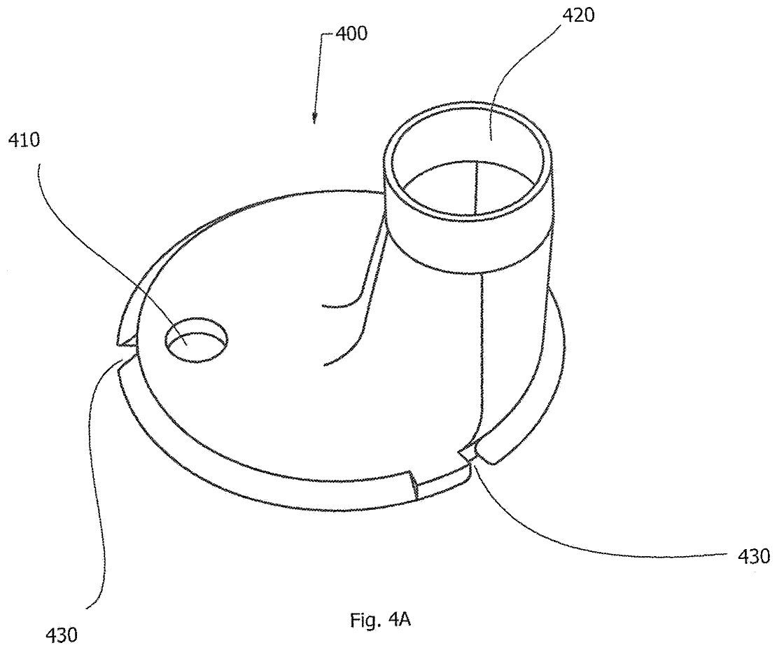

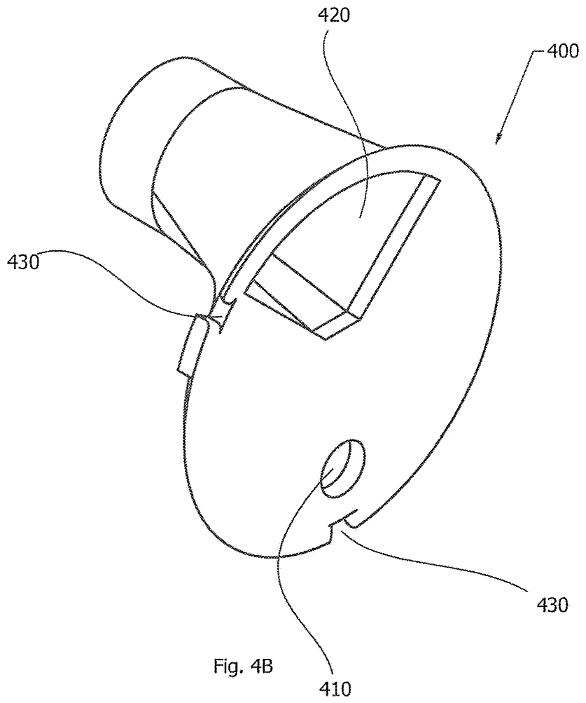

FIG. 2 shows an exploded view of a package 100 according to the present disclosure including the bottom, wherein the bottom comprises a first part 200 and a second part 300. The figure further shows a receiving portion 400 intended to be provided at a device for receiving the powder, such as a 3D printer. The receiving portion 400 will be further described in reference to FIGS. 4a and 4b.

FIG. 2 further shows the positioning of the first part 200 relative to the second part 300 of the bottom of the package 100 in the closed position. Typically, in the closed position, the second part 300 of the bottom is offset relative to the first part 200 with approximately 90°. In order to open the package, i.e. put the package into the open position, the second part 300 is rotated 90° relative to the first part 200. In some embodiments, there are no positions between the open position and the closed position in which the package can be positioned, and the package comprises means to move the second and/or first part relative to each other in case a user tries to position the package in a position between the open and closed position, such that the package moves into the open or closed position.

FIG. 3a shows the first part 200 of the bottom of the package. The first part 200 of the bottom is preferably circular in shape, although in some embodiments it may be rectangular, in some further embodiments with rounded corners. The first part 200 comprises an inlet aperture 210, adapted to let air into the package when it is in the open position, in order to facilitate emptying powder from the package. The first part 200 further comprises an outlet aperture 220, adapted to let powder out of the package when the package is in the open position. The first part 200 further comprises two protrusions 230, positioned asymmetrically in relation to the circumference of the first part 200. Having the inlet aperture 210 positioned at the bottom of the package rather than the top, improves the properties of how the air travels throughout the package in order to avoid collections of powder building up. In some embodiments, the second part 300 is adapted to be placed on the first part 200 such that the protrusions 230 holds the second part 300 in place relative to the first part 200.

FIG. 3b shows the second part 300 of the bottom of the package. The second part also comprises an inlet aperture 310 and an outlet aperture 320, wherein the inlet aperture 310 and the outlet aperture 320 are adapted to respectively align with the inlet aperture and the outlet aperture of the first part 200 when the package is in the open position. The inlet aperture 310 projects slightly from the body of the second part 300, such that it can be inserted into a corresponding opening of a receiving portion of a receiving device. In the closed position, the inlet aperture 310 and the outlet aperture 320 are displaced relative to the inlet aperture and the outlet aperture of the bottom part, such that no parts of either the inlet aperture 310 or the outlet aperture 320 of the second part overlap with either of the inlet aperture and the outlet aperture of the first part.

FIG. 4a shows a top side of a receiving portion 400 according to the present disclosure, adapted to be positioned in a device for receiving the powder from the package, such as a 3D-printer, or more specifically the powder container of a 3D-printer. The receiving portion comprises an opening 410, adapted to receive the inlet aperture 310 of the second part of the bottom. The receiving portion 400 further comprises an inlet aperture 420, adapted to be aligned with the inlet aperture of the first part and the second part of the bottom, when the package is in the open position. The receiving portion 400 further comprises two recesses 430, adapted to engage with the protrusions 230 of the first part, such that there is only one position in which the package may be inserted into the receiving portion in order for it to be rotatable.

FIG. 4b shows a bottom side of a receiving portion 400 according to the present disclosure. The package, more specifically the bottom part of the package, is intended to be inserted into the receiving portion from the bottom side. The inlet aperture 420 may in some embodiments be adapted to have a similar shape as the inlet apertures of the first and second parts of the bottom, on the bottom side.

In some embodiments, the package can only be opened when the bottom part of the package comes into contact with a compatible receiving portion. Such a mechanism may be achieved with e.g. a spring-loaded pin that locks the second part of the bottom to rotate relative to the first part of the bottom until the package comes into contact with a compatible receiving portion. In some embodiments, such a locking mechanism may also be applied until a sensor of the package senses that it is in proximity of a corresponding sensor of a receiving device, indicating that the package and the receiving device are compatible. In some embodiments, the locking mechanism may be adapted to only open both when a sensor senses proximity of a corresponding sensor, and when the package comes into contact with a compatible receiving portion.

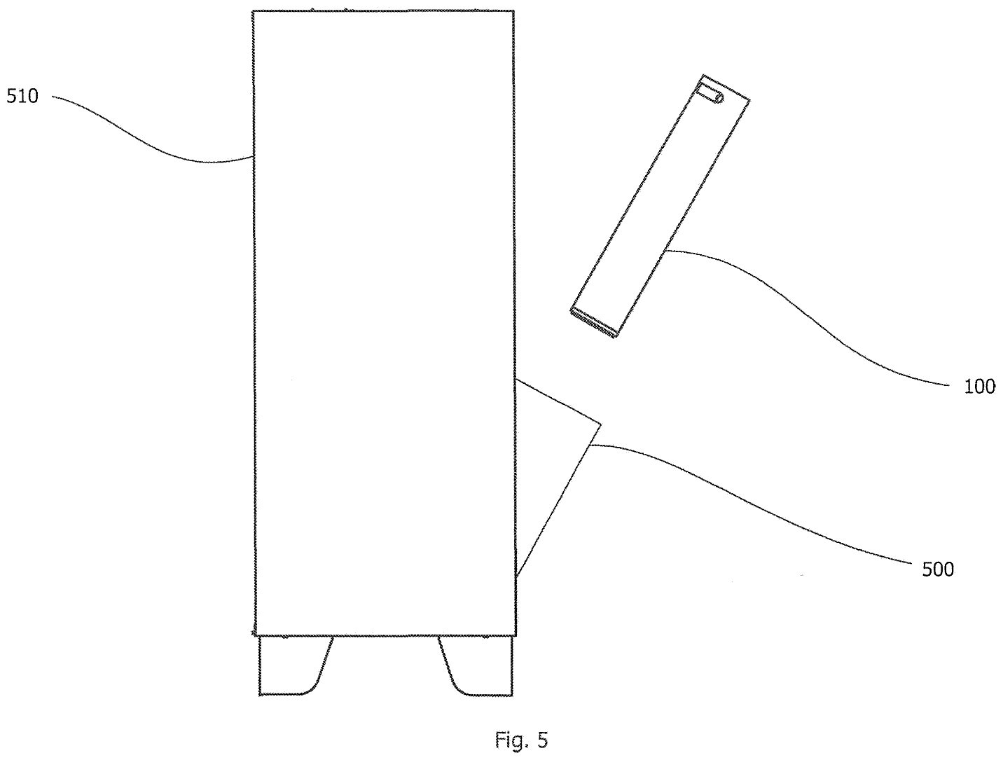

FIG. 5 shows an overview of the package 100 according to the present disclosure and a device 510 adapted for receiving the powder contained in the package. A typical interaction between the package 100 and the receiving device 510 will now be described.

The device 510 comprises a receiving device 500, comprising the receiving portion 400 of FIG. 3c. The package 100 is inserted into the receiving portion 400 of the receiving device 500, when the package is in a closed position. The inlet aperture 310 of the second part is then inserted into the corresponding opening 410 of the receiving portion 400, and the protrusions 230 of the first part engage with the corresponding recesses 430 on the receiving portion, which locks the second part in place relative to the receiving portion. After this, it is possible to rotate the package from the closed position to the open position, which in some embodiments entails a rotation of approximately 90°. This procedure entails that the first part 200 rotates relative to the second part 300 and the receiving portion 400, such that the inlet aperture 210 of the first part aligns with the inlet aperture 310 of the second part and with the opening 410 of the receiving portion, and the outlet aperture 220 of the first part aligns with the outlet aperture 320 of the second part and the inlet aperture 420 of the receiving portion. The powder is then transported from the package into the receiving device 510, in some embodiments by use of negative pressure provided by the device 510. After the powder has been emptied, the user may rotate the package 90° in the opposite direction relative to the first rotation of the package, in order to enable the package to be removed from the receiving device.

In some embodiments, the package 100 cannot be opened, i.e. moved from the closed position to the open position, until it comes into contact with a compatible receiving device 500, wherein coming into contact entails that the inlet aperture 310 of the second part is inserted into the opening 410 of the receiving portion, and the protrusions 230 of the second part engage with the recesses 430 of the receiving portion. In some embodiments, the package 100 cannot be removed from the receiving device 500 until it is rotated back into the closed position.

In some embodiments, the package 100 and the receiving device 510 may be provided with sensors. The sensors of the receiving device 510 are adapted to sense the presence of a corresponding and/or compatible sensor of a package 100, and the package and the receiving device 510 may further be provided with means for indicating to a user that a package is in proximity to the device 510. The indicating means may further be adapted to indicate whether the package in proximity to the device is an allowable package, which may further increase the safety of the system. In some embodiments, it is not possible to insert the package 100 into the device 510, unless the sensor of the device 510 has recognized by the sensor of the package 100 that the package 100 is a package intended to be used for this particular device. In some embodiments, this is achieved by way of a mechanical latching device which prevents the first part of the bottom to rotate relative to the second part of the bottom, until the interaction between the sensors unlocks the latching device.

In some embodiments, what is considered proximity of the first and second sensors is relatively short, such as approximately 0.1-1 meters. In some embodiments, the first and/or second sensors may be equipped with visual means to indicate when they are on the way of coming into proximity of the other of the first and second sensor, for example by the visual means starting to blink and/or changing color as the first sensor of the package comes closer to the second sensor of the receiving device. It is also possible that both the first and second sensor show corresponding visual indications, such that a user may know which package is compatible with which receiving device. In some embodiments, such visual indications may activate when the first sensor is within a distance of approximately 5-30 meters of the second sensor, and increase in intensity and/or change color as the distance between the sensors decreases. Such visual indications may help a user locate the correct receiving device for a package, which is especially advantageous in case of a facility comprising multiple different receiving devices which are compatible with different packages.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more”. Moreover, it is not necessary for an apparatus or method to address each and every problem sought to be solved by the presently described concept, for it to be encompassed hereby.

1. A package for powder for additive manufacturing having an open position and a closed position, comprising:
a body;
a top, disposed at the top of the body;
a bottom, disposed at the bottom of the body, wherein the bottom comprises:
a first part having an inlet aperture and an outlet aperture, spaced apart from each other;
a second part having an inlet aperture and an outlet aperture, spaced apart from each other, wherein the second part is displaceable relative to the first part;
wherein, in the closed position, the first part is offset relative to the second part, such that neither of the inlet aperture and the outlet aperture of the first part overlap with either of the inlet aperture and the outlet aperture of the second part; and
wherein, in the open position, the inlet aperture of the first part is aligned with the inlet aperture of the second part and the outlet aperture of the first part is aligned with the outlet aperture of the second part.

2. The package according to claim 1, wherein the first part comprises two protrusions for engaging with a receiving device.

3. The package according to claim 1, wherein in the closed position, the second part is offset with approximately 90° relative to the first part.

4. The package according to claim 1, further comprising a sensor for sensing if the package is in proximity of a compatible receiving device.

5. The package according to claim 1, wherein the top and the bottom are circular and the body is cylindrical.

6. The package according to claim 1, comprising a mechanical latching device for locking the second part of the bottom relative to the first part of the bottom, until the package comes into contact with a compatible receiving device.

7. System for filling of powder in additive manufacturing, comprising:
a package according to claim 1; and
a receiving portion, comprising an opening and an inlet aperture, wherein the receiving portion is adapted to engage with the bottom of the package, such that the package can only be opened after engagement of the bottom and the receiving portion, and subsequent rotation of the package.

8. System according to claim 7, wherein the first part of the bottom of the package comprises two protrusions and the receiving portion comprises two recesses adapted to engage with the protrusions of the second part.

9. System according to claim 7, wherein the inlet aperture of the second part is adapted to be inserted into the opening of the receiving portion.

10. System according to claim 7, wherein the package comprises a first sensor and wherein the receiving portion comprises a second sensor, wherein the first sensor and/or the second sensor is adapted to sense if it is in the vicinity of the other of the first and/or second sensor.
